(19) United States
(12) Patent Application Publication
(10) Pub. No.: US 2010/0208073 A1
(43) Pub. Date: Aug. 19, 2010

(54) OUTSIDE VIEW MONITOR SYSTEM AND VEHICLE HAVING THE SAME

(75) Inventor: Toshihiro HATTORI, Okazaki-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 12/702,382

(22) Filed: Feb. 9, 2010

(30) Foreign Application Priority Data
Feb. 19, 2009 (JP) 2009-36283

(51) Int. Cl. H04N 7/18

(52) U.S. Cl. 348/148; 348/E07.085

(57) ABSTRACT

A monitor system for a vehicle includes a camera, a display, a failure detection device, and a prohibition control device. The camera captures an image of an area around the vehicle. The display displays the captured image to a driver of the vehicle. The failure detection device detects a failure of a function that allows the display to display the captured image. The prohibition control device prohibits the vehicle from being driven, when the failure detection device detects the failure of the function.

### CROSS REFERENCE TO RELATED APPLICATION

This application is based on and incorporates herein by reference Japanese Patent Application No. 2009-36283 filed on Feb. 19, 2009.

### FIELD OF THE INVENTION

The present invention relates to an outside view monitor system and a vehicle having the outside view monitor system.

In a conventional outside view monitor system, an image of the area around the vehicle is captured by a camera mounted on the vehicle, and the captured image is displayed on a display inside the vehicle so that a driver of the vehicle can see the image. JP-2002-163792A discloses a technique for detecting a failure of such a system and for reporting occurrence of the failure to a driver.

However, according to the technique of JP-2002-163792A, when the failure is detected and reported to the driver, the driver needs to decide on his/her own whether to stop driving the vehicle. Therefore, the driver may continue to drive the vehicle even in a situation where the vehicle should be stopped due to the failure.

### SUMMARY OF THE INVENTION

In view of the above, it is an object of the present invention to reduce a risk that a driver of a vehicle drives the vehicle in the event of a failure of a function that captures an image of the area around the vehicle and displays the captured image to the driver.

According to an aspect of the present invention, a monitor system for a vehicle includes a camera, a display, a failure detection device, and a prohibition control device. The camera captures an image of an area around the vehicle. The display displays the captured image to a driver of the vehicle. The failure detection device detects a failure of a function that allows the display to display the captured image. The prohibition control device prohibits the vehicle from being driven in response to detection of the failure by the failure detection device. The prohibition control device preferably can provide the driver with a warning that urges the driver to stop the vehicle, when the vehicle runs at the time of the detection of the failure. In this case, the prohibition control device prohibits the vehicle from being driven, after the vehicle is stopped. The monitor system further can include a substitute device that serves as a substitute for the function and allows the driver to see the area around the vehicle without the function. In this case, the prohibition control device removes prohibition on driving the vehicle, when the substitute device is in use.

According to another aspect of the present invention, a vehicle includes the monitor system. The function of the monitor system serves as a substitute for at least one of a side mirror and a rear view mirror. The vehicle does not have the at least one of the side mirror and the rear view mirror.

### BRIEF DESCRIPTION OF THE DRAWINGS

The above and other objectives, features and advantages of the present invention will become more apparent from the following detailed description made with check to the accompanying drawings. In the drawings:

FIG. 1 is a block diagram illustrating an electronic mirror system according to an embodiment of the present invention;

FIG. 2 is a diagram illustrating a left side marker lamp of a vehicle;

FIG. 3 is a diagram illustrating a left side camera and a left side light emitter attached to the left side maker lamp;

FIG. 4 is a diagram illustrating a fin antenna mounted on the top of the vehicle;

FIG. 5 is a diagram illustrating the fin antenna mounted on the rear of the vehicle;

FIG. 6 is a diagram illustrating a center camera and a center light emitter attached to the fin antenna;

FIG. 7 is a block diagram illustrating a controller;

FIG. 8 is a diagram illustrating a substitute left side mirror and the left side light emitter in normal times;

FIG. 9 is a diagram illustrating an image displayed on a screen of a left side display;

FIG. 10 is a flow diagram illustrating a failure handling function performed by the controller;

FIG. 11 is a diagram illustrating the left side light emitter at the time of occurrence of a failure;

FIG. 12 is a diagram illustrating a warning displayed to a driver of the vehicle at the time of occurrence of the failure; and

FIG. 13 is a diagram illustrating the substitute left side mirror that is in use.

### DETAILED DESCRIPTION OF THE PREFERRED EMBODIMENT

An electronic mirror system according to an embodiment of the present invention is described below with reference to the drawings. The electronic mirror system is one example of an outside view monitor system. The electronic mirror system is mounted on a vehicle 100, captures an image of the area around the vehicle 100, and displays the captured image to a driver inside the vehicle 100. Thus, the electronic mirror system can serve as a substitute for left and right side mirrors and a rear view mirror.

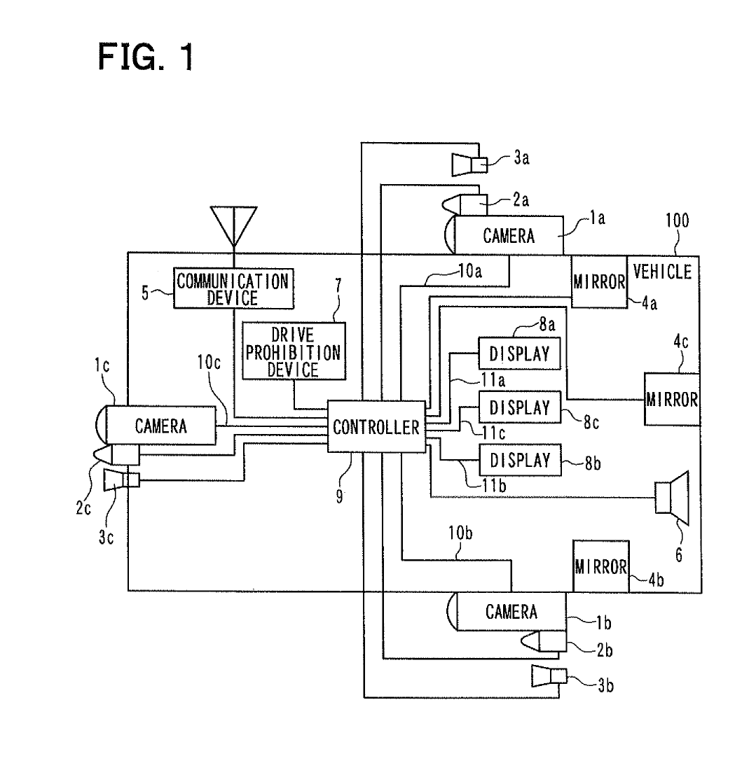

As shown in FIG. 1, the electronic mirror system includes a camera group of cameras 1a-1c, a light group of light emitters 2a-2c, a sound group of sound emitters 3a-3c, a mirror group of substitute mirrors 4a-4c, a communication device 5, a voice output device 6, a drive prohibition device 7, a display group of displays 8a-8c, a controller 9, and a cable group of cables. These components are connected together by the cable group. For example, the cable group includes cables 10a-10c and cables 11a-11c.

The camera group includes a left side camera 1a, a right side camera 1b, and a center camera 1c. Each of the cameras 1a-1c repeatedly captures an image of its respective capture area at a predetermined regular interval (e.g., thirty images per second) and sequentially outputs a signal of the captured image to the controller 9.

The left side camera 1a is mounted to a left door of the vehicle 100. Specifically, the left side camera 1a is mounted near a position where a left side mirror is generally located. Thus, the left side camera 1a can capture an image of the area that is generally seen in a left side mirror by a driver seated in a driver's seat of the vehicle 100. That is, the left side camera 1a can capture and image of the area behind and to the left of the vehicle 100.

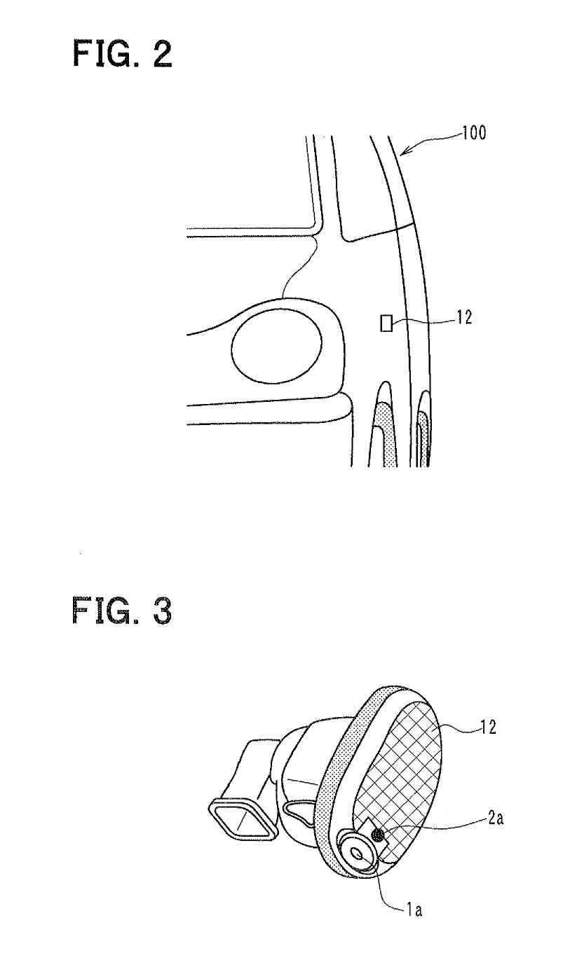

For example, the left side camera 1a can be mounted to a left side marker lamp 12, shown in FIG. 2, of the vehicle 100. In this case, as shown in FIG. 3, the left side camera 1a can be mounted to a rear end portion of the left side marker lamp 12.

The right side camera 1b is mounted to a right door of the vehicle 100. Specifically, the right side camera 1b is mounted near a position where a right side mirror is generally located. Thus, the right side camera 1b can capture an image of the area that is generally seen in a right side mirror by the driver seated in the driver's seat. That is, the right side camera 1b can capture an image of the area behind and to the right of the vehicle 100. For example, the right side camera 1b can be mounted to a right side marker lamp (not shown) of the vehicle 100. In this case, the right side camera 1b can be mounted to a rear end portion of the right side marker lamp.

The center camera 1c is mounted on the top (e.g., roof) or the rear (e.g., trunk) of the vehicle 100. Thus, the center camera 1c can capture an image of the area that is generally seen in a rear view mirror by the driver seated in the driver's seat. That is, the center camera 1c can capture an image of the area directly behind the vehicle 100.

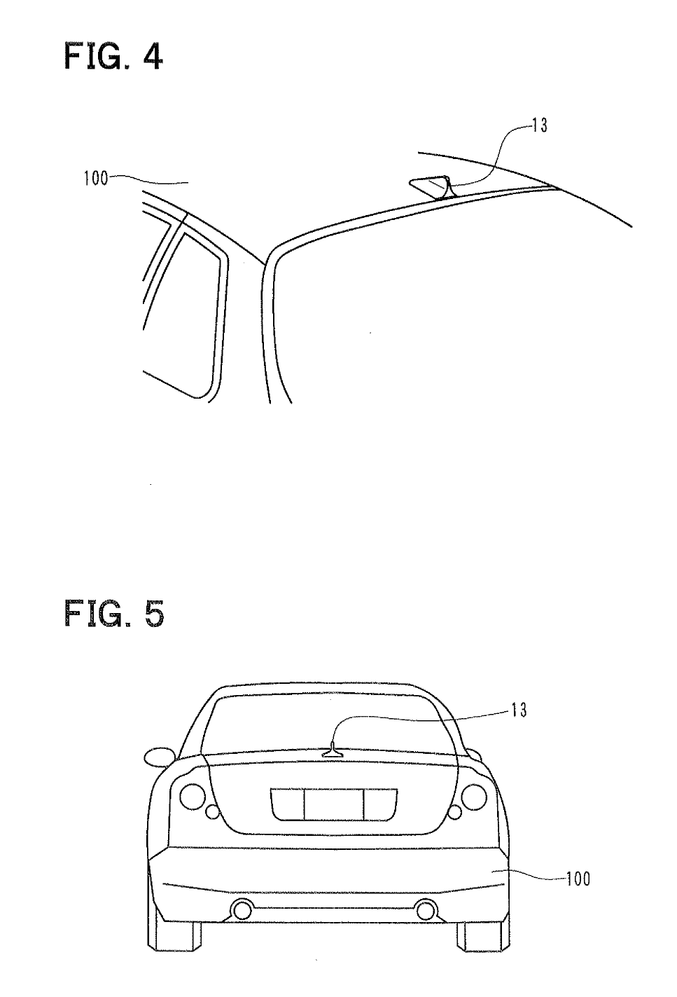

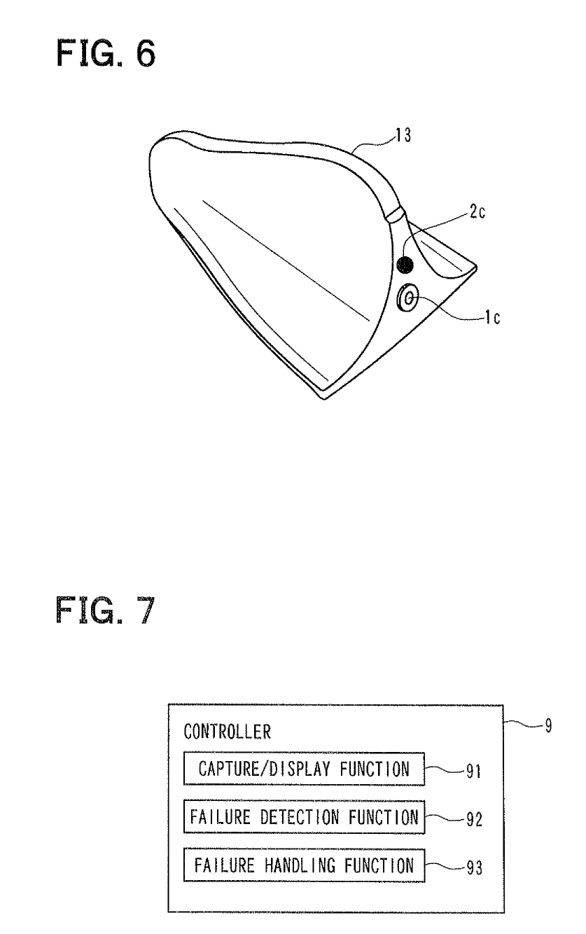

For example, the center camera 1c can be mounted to a fin antenna 13 shown in FIGS. 4 and 5. In the example shown in FIG. 4, the fin antenna 13 is mounted on the top of the vehicle 100. In the example shown in FIG. 5, the fin antenna 13 is mounted on the rear of the vehicle 100. In each example, as shown in FIG. 6, the center camera 1c can be mounted to a rear end portion of the fin antenna 13. The fin antenna 13 is used for transmission and reception of a wireless signal by a wireless communication apparatus (e.g., the communication device 5) mounted on the vehicle 100.

The light group includes a left side light emitter 2a, a right side light emitter 2b, and a center light emitter 2c. Each of the light emitters 2a-2c emits a light toward the area around the vehicle 100. For example, each of the light emitters 2a-2c can be a light emitting diode (LED) or the like.

The left side light emitter 2a is mounted near the left side camera 1a. For example, the left side light emitter 2a can be mounted within twenty centimeters from the left side camera 1a. For example, as shown in FIG. 3, along with the left side camera 1a, the left side light emitter 2a can be mounted to the rear end portion of the left side maker lamp 12 of the vehicle 100.

The right side light emitter 2b is mounted near the right side camera 1b. For example, the right side light emitter 2b can be mounted within twenty centimeters from the right side camera 1b. For example, along with the right side camera 1b, the right side light emitter 2b can be mounted to the rear end portion of the right side maker lamp of the vehicle 100.

The center light emitter 2c is mounted near the center camera 1c. For example, the center light emitter 2c can be mounted within twenty centimeters from the center camera 1c. For example, as shown in FIG. 6, along with the center camera 1c, the center light emitter 2c can be mounted to the rear end portion of the fin antenna 13.

The sound group includes a left side sound emitter 3a, a right side sound emitter 3b, and a center sound emitter 3c. Each of the sound emitters 3a-3c emits a sound toward the area around the vehicle 100 so that the sound can be heard by a person within a predetermined distance from the vehicle 100. For example, the magnitude of the sound is large enough to be heard by a person within a radius of ten meters from the vehicle 100. For example, each of the sound emitters 3a-3c can be a buzzer or the like.

The left side sound emitter 3a is mounted near the left side camera 1a. For example, the left side sound emitter 3a can be incorporated (e.g., imbedded) in the left side marker lamp 12 to which the left side camera 1a is mounted.

The right side sound emitter 3b is mounted near the right side camera 1b. For example, the right side sound emitter 3b can be incorporated (e.g., imbedded) in the right side marker lamp to which the right side camera 1b is mounted.

The center sound emitter 3c is mounted near the center camera 1c. For example, the center sound emitter 3c can be incorporated (e.g., imbedded) in the fin antenna 13 to which the center camera is mounted.

The mirror group includes a substitute left side mirror 4a, a substitute right side mirror 4b, and a substitute rear view mirror 4c. The substitute mirrors 4a-4c are used when it is impossible for the electronic mirror system to display the image of the area around the vehicle 100. That is, in normal times where the electronic mirror system operates properly, the substitute mirrors 4a-4c are not used.

The substitute left side mirror 4a is mounted near the left side camera 1a and used when the image captured by the left side camera 1a cannot be displayed. The substitute right side mirror 4b is mounted near the right side camera 1b and used when the image captured by the right side camera 1b cannot be displayed. The substitute rear view mirror 4c is mounted in a position where a rear view mirror is generally located.

The substitute rear view mirror 4c is used when the image captured by the center camera 1c cannot be displayed.

When unused, each of the substitute left side mirror 4a and the substitute right side mirror 4b is folded or accommodated inside the vehicle 100 so as not to cause an obstruction to objects around the vehicle 100. When unused, the substitute rear view mirror 4c is folded or accommodated inside the vehicle 100 so as not to cause an obstruction to the driver's view. When used, each of the folded or accommodated mirrors 4a-4c is unfolded or appears from the inside of the vehicle 100.

The controller 9 can control each of the substitute mirrors 4a-4c so that each of the substitute mirrors 4a-4c can be automatically moved between a unused position (e.g., folded position) and a used position (e.g., unfolded position). The controller 9 can detect whether each of the substitute mirrors 4a-4c is in the unused position or in the used position by a conventional detection technique. Further, each of the substitute mirrors 4a-4c can be moved manually between the unused position and the used position.

The communication device 5 is a circuit for establishing wireless communication with an external wireless communication apparatus (e.g., a failure reporting center for receiving and recording failure information reported from vehicles) located outside the vehicle 100 by performing various processes including amplification, modulation, demodulation, frequency conversion, encoding, and decoding. The controller 9 can perform wireless communication with the external wireless communication apparatus through the communication device 5.

The voice output device 6 is a device such as a speaker and outputs a voice sound inside the vehicle 100.

The drive prohibition device 7 can be an electronic control unit (ECU). The drive prohibition device 7 can perform a drive prohibition control in accordance with a drive prohibition instruction from the controller 9, thereby prohibiting the vehicle 100 from be being driven. Further, the drive prohibition device 7 can stop the drive prohibition control in accordance with a drive prohibition removal instruction from the controller 9, thereby removing prohibition on driving the vehicle 100 (i.e., allowing the vehicle 100 to be driven).

For example, the drive prohibition device 7 can be a brake ECU that controls a brake of the vehicle 100. In this case, if the vehicle 100 is running at the time of receipt of the driving prohibition instruction, the drive prohibition device 7 can put the brake into a brake lock mode after waiting for the vehicle 100 to be stopped. The brake lock mode locks the brake so that the brake cannot be released manually. In contrast, if the vehicle 100 is stopped at the time of receipt of the driving prohibition instruction, the drive prohibition device 7 can put the brake into the lock mode immediately after the receipt of the driving prohibition instruction.

For another example, the drive prohibition device 7 can be an engine ECU that controls an engine of the vehicle 100. In this case, the drive prohibition device 7 can put the engine into an engine lock mode when receiving the driving prohibition instruction from the controller 9. When the engine is in the engine lock mode, the engine cannot be started even by an operation of the driver so that driving the vehicle 100 can be prohibited.

The display group includes a left side display 8a, a right side display 8b, and a center display 8c. The displays 8a-8c display the images captured by the cameras 1a-1c, respectively.

The left side display 8a displays the image captured by the left side camera 1a. The left side display 8a is mounted in front and to the left of the driver in such a manner that a screen of the left side display 8a can face the driver. For example, when the vehicle 100 is a right hand drive, the left side display 8a can be mounted to a center portion of an instrument panel of the vehicle 100, and when the vehicle 100 is a left hand drive, the left side display 8a can be mounted to a left end portion of the instrument panel. In such an approach, the driver can see the left side display 8a by looking to the left like seeing a left side mirror. The driver can obtain the same or more information by seeing the left side display 8a than information obtained by seeing a left side mirror. In this way, a combination of the left side camera 1a and the left side display 8a can serve as a substitute for a left side mirror.

The right side display 8b displays the image captured by the right side camera 1b. The right side display 8b is mounted in front and to the right of the driver in such a manner that a screen of the right side display 8b can face the driver. For example, when the vehicle 100 is a right hand drive, the right side display 8b can be mounted to a right end portion of the instrument panel of the vehicle 100, and when the vehicle 100 is a left hand drive, the right side display 8b can be mounted to the center portion of the instrument panel. In such an approach, the driver can see the right side display 8b by looking to the right like seeing a right side mirror. The driver can obtain the same or more information by seeing the right side display 8b than information obtained by seeing a right side mirror. In this way, a combination of the right side camera 1b and the right side display 8b can serve as a substitute for a right side mirror.

The center display 8c displays the image captured by the center camera 1c. The center display 8c is mounted between the left side display 8a and the right side display 8b with respect to the driver in such a manner that a screen of the center display 8c can face the driver. For example, the center display 8c can be mounted to the installment panel at a position directly in front of the driver. For another example, like a rear view mirror, the center display 8c can be mounted to a front end portion of a ceiling of the vehicle 100. In such an approach, the driver can see the center display 8c like seeing a rear view mirror. The driver can obtain the same or more information by seeing the center display 8c than information obtained by seeing a rear view mirror. In this way, a combination of the center camera 1c and the center display 8c can serve as a substitute for a rear view mirror.

The controller 9 has a typical microcomputer including a central processing unit (CPU), a random access memory (RAM), and a read only memory (ROM). As shown in FIG. 7, the controller 9 is configured to perform at least three functions: a capture/display function 91, a failure detection function 92, and a failure handling function 93.

The CPU of the controller 9 executes programs stored in the ROM, thereby performing various functions including the capture/display function 91, the failure detection function 92, and the failure handling function 93. When executing the programs, the CPU can exchange signals with the camera group of the cameras 1a-1c, the light group of the light emitters 2a-2c, the sound group of the sound emitters 3a-3c, the mirror group of the substitute mirrors 4a-4c, the communication device 5, the voice output device 6, the drive prohibition device 7, and the display group of the displays 8a-8c.

Operations of the controller 9 (i.e., the CPU) are described below. As mentioned above, the controller 9 can perform the capture/display function 91, the failure detection function 92, and the failure handling function 93.

Firstly, the capture/display function 91 is discussed. The capture/display function 91 allows the images captured by the cameras 1a-1c to be displayed on the displays 8a-8c, respectively.

Specifically, the capture/display function 91 includes three sub-functions: a left capture/display function, a right capture/display function, and a center capture/display function.

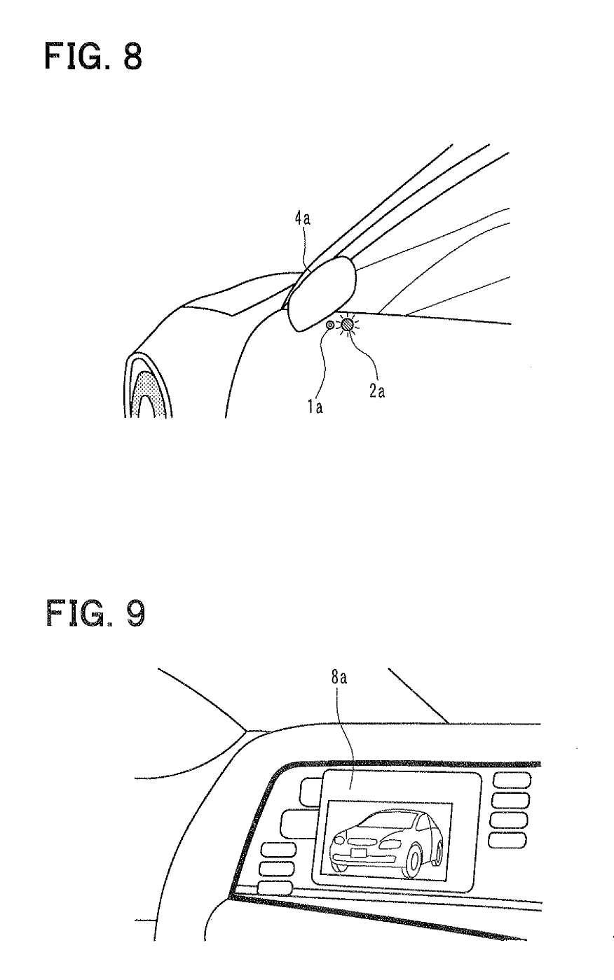

In the left capture/display function, the controller 9 sequentially receives the captured image from the left side camera 1a in real time and causes the left side display 8a to sequentially display the received image in real time. FIG. 9 depicts an example of the image displayed on the left side display 8a. For example, the controller 9 receives thirty images per second from the left side camera 1a. As long as the left capture/display function works properly, the substitute left side mirror 4a is kept in the unused position, and the left side light emitter 2a is kept in a failure non-reporting position as shown in FIG. 8. The left side light emitter 2a emits a light with a first color in the failure non-reporting position and emits a light with a second color different from the first color in a failure reporting position. For example, the left side light emitter 2a emits a green light in the failure non-reporting position and emits a red light in the failure reporting position. Details of the failure reporting position and the failure non-reporting position are described later.

Likewise, in the right capture/display function, the controller 9 sequentially receives the captured image from the right side camera 1b in real time and causes the right side display 8b to sequentially display the received image in real time. For example, the controller 9 receives thirty images per second from the right side camera 1b. As long as the right capture/display function works properly, the substitute right side mirror 4b is kept in the unused position, and the right side light emitter 2b is kept in the failure non-reporting position.

Likewise, in the center capture/display function, the controller 9 sequentially receives the captured image from the center camera 1c in real time and causes the center display 8c to sequentially display the received image in real time. For example, the controller 9 receives thirty images per second from the center camera 1c. As long as the center capture/display function works properly, the substitute rear view mirror 4c is kept in the unused position, and the center light emitter 2c is kept in the failure non-reporting position.

The controller 9 can perform signal processing on the images received from the cameras 1a-1c before causing the displays 8a-8c to display the received images. For example, the signal processing can include distortion correction and trimming.

Next, the failure detection function 92 is discussed. The failure detection function 92 repeatedly checks for failure of the capture/display function 91 at a predetermined regular interval (e.g., once per second). Specifically, the failure detection function 92 separately (i.e., individually) checks for failure of the left capture/display function, the right capture/display function, and the center capture/display function. The controller 9 can serve as a failure detection device by performing the failure detection function 92.

When a failure of the capture/display function 91 occurs, there is a possibility that the failure occurs in any of the cameras 1a-1c, the cables 10a-10c that connect the controller 9 to the cameras 1a-1c, the cables 11a-11c that connect the controller 9 to the displays 8a-8c, and the displays 8a-8c.

As described above, according to the embodiment, the failure detection function 92 separately checks for failure of the left capture/display function, the right capture/display function, and the center capture/display function. Therefore, the cameras 1a-1c, the cables 10a-10c, the cables 11a-11c, and the displays 8a-8c are not separately checked for failure. Specifically, the cameras 1a-1c, the cables 10a-10c, the cables 11a-11c, and the displays 8a-8c are divided into sets, and each set is separately checked for failure. More specifically, the cameras 1a-1c, the cables 10a-10c, the cables 11a-11c, and the displays 8a-8c are divided into the following six sets (A)-(F).

(A) the left side camera 1a and the cable 10a that connects the left side camera 1a to the controller 9.

(B) the right side camera 1b and the cable 10b that connects the right side camera 1b to the controller 9.

(C) the center camera 1c and the cable 10c that connects the center camera 1c to the controller 9.

(D) the left side display 8a and the cable 11a that connects the left side display 8a to the controller 9.

(E) the right side display 8b and the cable lib that connects the right side display 8b to the controller 9.

(F) the center display 8c and the cable 11c that connects the center display 8c to the controller 9.

In an example, the sets (A)-(C) are checked for failure based on whether normal image signals (e.g., synchronization signals within a normal range) are received from the cable 10a-10c.

In another example, request signals are transmitted through the cables 10a-10c to the cameras 1a-1c, and the sets (A)-(C) are checked for failure based on whether response signals corresponding to the request signals are returned.

In another example, a speed of the vehicle 100 is detected based on a signal from a speed sensor (not shown) mounted on the vehicle 100, and it is determined, based on the detected speed, whether or not the vehicle 100 is running. If it is determined that the vehicle 100 is running, the sets (A)-(C) can be checked for failure based on whether images received through the cables 10a-10c change with time. That is, the sets (A)-(C) can be checked for failure based on whether the images outputted from the cameras 1a-1c are frozen.

The sets (D)-(F) can be checked for failure in the same manner as the sets (A)-(C). In an example, request signals are transmitted through the cables 11a-11c to the displays 8a-8c, and the sets (D)-(F) are checked for failure based on whether response signals corresponding to the request signals are returned.

Finally, the failure handling function 93 is discussed. When the failure detection function 92 detects occurrence of a failure of the capture/display function 91, the failure handling function 93 reports the occurrence of the failure to a person around the vehicle 100 as needed and prohibits the vehicle 100 from being driven as needed.

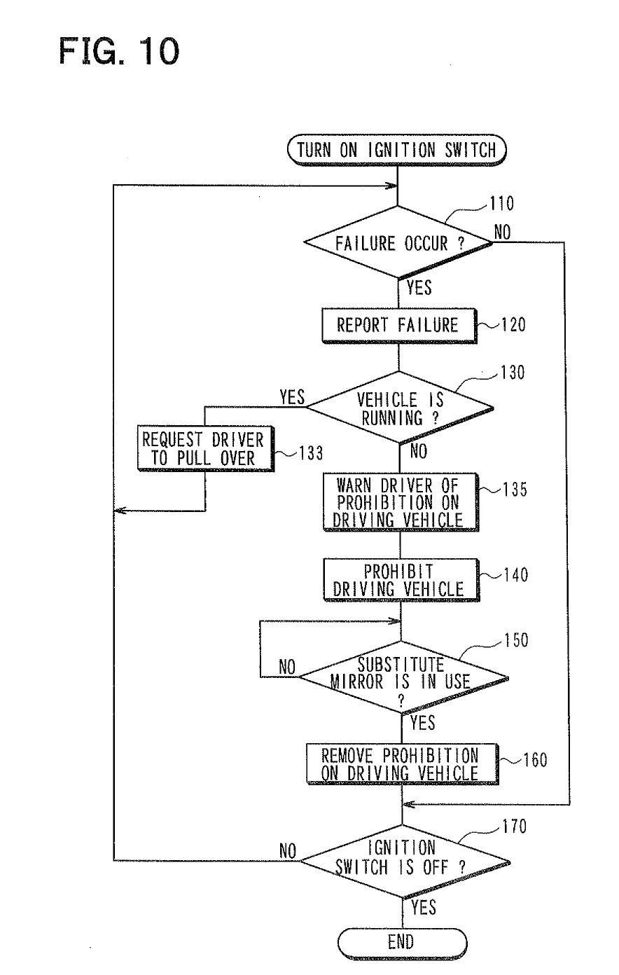

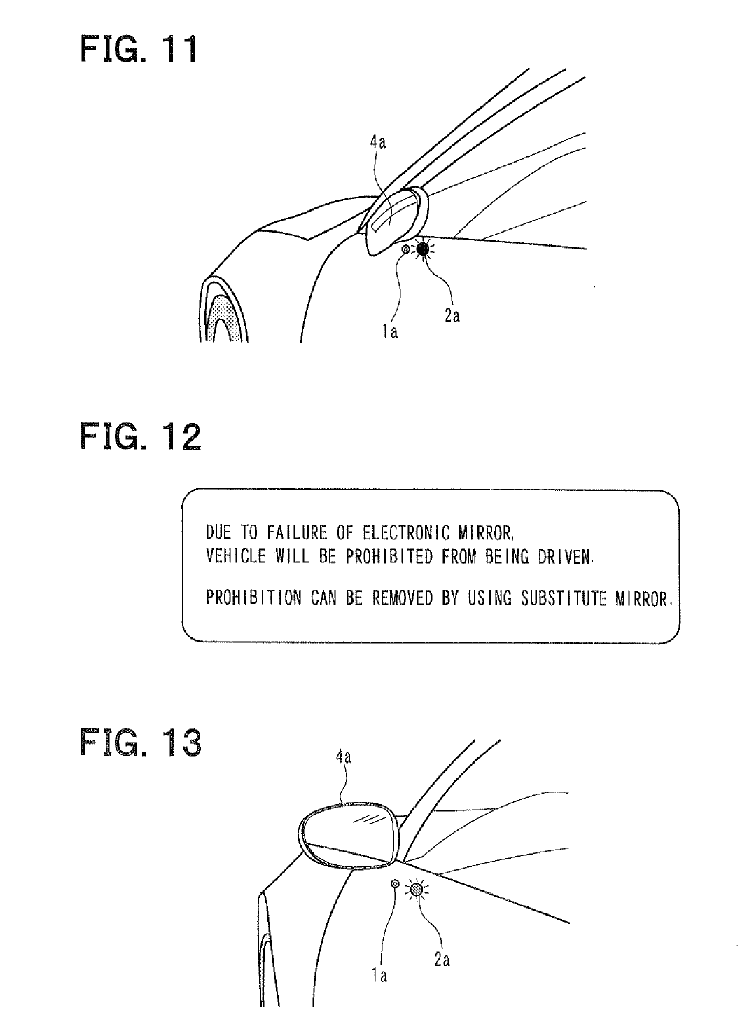

Specifically, when an ignition switch of the vehicle 100 is turned ON, the controller 9 starts to execute a failure handling program shown in FIG. 10, thereby starting to perform the failure handling function 93.

The failure handling program starts at step 110, where the controller 9 determines whether a failure occurs. Specifically, it is determined, based on the check result of the failure detection function 92, whether a failure occurs in the left capture/display function, the right capture/display function, and the center capture/display function. If the controller 9 determines that a failure occurs in at least one of the left capture/display function, the right capture/display function, and the center capture/display function corresponding to YES at step 110, the failure handling program proceeds to step 120. In contrast, if the controller 9 determines that a failure does not occur in any of the left capture/display function, the right capture/display function, and the center capture/display function corresponding to NO at step 110, the failure handling program jumps to step 170.

Specifically, if the check result of the failure detection function 92 indicates that a failure occurs in at least one of the set (A) and the set (D), the controller 9 determines that a failure occurs in the left capture/display function. In contrast, if the check result of the failure detection function 92 indicates that a failure occurs in neither the set (A) nor the set (D), the controller 9 determines that the left capture/display function operates properly.

If the check result of the failure detection function 92 indicates that a failure occurs in at least one of the set (B) and the set (E), the controller 9 determines that a failure occurs in the right capture/display function. In contrast, if the check result of the failure detection function 92 indicates that a failure occurs in neither the set (B) nor set (E), the controller 9 determines that the right capture/display function operates properly.

If the check result of the failure detection function 92 indicates that a failure occurs in at least one of the set (C) and the set (F), the controller 9 determines that a failure occurs in the center capture/display function. In contrast, if the check result of the failure detection function 92 indicates that a failure occurs in neither the set (C) nor the set (F), the controller 9 determines that the center capture/display function operates properly.

At step 120, the controller 9 reports occurrence of a failure of the capture/display function 91. Specifically, at step 120, the light emitter corresponding to the capture/display function that is determined at step 110 to have a failure is put into the failure reporting position. As described previously, the light emitter emits a light with the second color (e.g., red) in the failure reporting position. Further, at step 120, the sound emitter corresponding to the capture/display function that is determined at step 110 to have a failure is activated to emit a sound.

For example, assuming that it is determined at step 110 that a failure occurs in only the left capture/display function, the left side light emitter 2a is put into the failure reporting position at step 120, and also the left side sound emitter 3a is activated at step 120. Thus, at step 120, the left side light emitter 2a emits a light with the second color, and the left side sound emitter 3a emits a sound. In this way, the controller 9 reports occurrence of a failure of the left capture/display function to a person around the vehicle 100.

Further, at step 120, the controller 9 can transmit failure information to the external wireless communication apparatus (e.g., the failure reporting center) by using the communication device 5. For example, the failure information can include an identification number of the vehicle 100 and a notice that a failure occurs in the capture/display function 91.

Then, the failure handling program proceeds to step 130. At step 130, the controller 9 determines, based on an output signal of a speed sensor (not shown) of the vehicle 100, whether or not the vehicle 100 is running. For example, when the output signal of the speed sensor indicates that a speed of the vehicle 100 is equal to or faster than a threshold speed (e.g., one kilometer per hour), the controller 9 determines that the vehicle 100 is running. In contrast, when the output signal of the speed sensor indicates that the speed of the vehicle 100 is slower than the threshold speed, the controller 9 determines that the vehicle 100 is stopped.

If the controller 9 determines that the vehicle 100 is running corresponding to YES at step 130, the failure handling program proceeds to step 133. In contrast, if the controller 9 determines that the vehicle 100 is stopped corresponding to NO at step 130, the failure handling program proceeds to step 135.

At step 133, the controller 9 reports the occurrence of the failure to the driver of the vehicle 100. Further, the controller 9 requests the driver to pull over to a safe place and stop the vehicle 100. For example, the controller 9 can cause at least one of the displays 8a-8c to display the following warning message: “Failure occurs in a right capture/display function. Please stop a vehicle in a safe place”. Further, the controller 9 can cause the voice output device 6 to generate an audible warning message having the same content as the displayed warning message. In this way, the controller 9 provides the driver with a warning that urges the driver to move the vehicle 100 to a safe place and stop the vehicle 100, when the vehicle is running at the time of the failure of the capture/display function 91.

The warning message can be displayed on only the display corresponding to the capture/display function that is determined at step 110 to have no failure. For example, assuming that it is determined at step 110 that a failure occurs in only the right capture/display function, the warning message can be displayed at step 120 on both the left side display 8a and the center display 8c. In this example, the warning message is not displayed on the right side display 8b.

After step 133 is executed, the failure handling program returns to step 110. Therefore, if a failure occurs in the capture/display function 91, the driver is repeatedly requested to pull over until the vehicle 100 is stopped. Then, when the vehicle 100 is stopped, the failure handling program proceeds from step 130 to step 135. It is noted that if the failed capture/display function 91 is recovered (i.e., cured) before the vehicle 100 is stopped, the failure handling program jumps from step 110 to step 170 by causing the light emitter in the failure reporting position to be in the failure non-reposting position and by causing the activated sound emitter to be deactivated.

At step 135, the controller 9 reports the occurrence of the failure to the driver of the vehicle 100. Further, the controller 9 notifies the driver that the vehicle 100 will be prohibited from being driven. For example, the controller 9 can cause at least one of the displays 8a-8c to display a warning message saying that a failure occurs in the capture/display function 91 and that the vehicle 100 will be prohibited from being driven. In this way, the controller 9 warns the driver that the vehicle 100 will be prohibited from being driven due to the failure of the capture/display function 91.

An example of the warning message displayed at step 135 is shown in FIG. 12. In the example shown in FIG. 12, the warning message says “Due to a failure of an electronic mirror, a vehicle will be prohibited from being driven. Prohibition can be removed by using a substitute mirror”. Further, the controller 9 can cause the voice output device 6 to generate an audible warning message having the same content as the displayed warning message.

Like at step 133, the warning message can be displayed on only the display corresponding to the capture/display function that is determined at step 110 to have no failure.

After step 135 is executed, the failure handling program proceeds to step 140, where the controller 9 prohibits the vehicle 100 from being driven. Specifically, the controller 9 sends the drive prohibition instruction to the drive prohibition device 7, and the drive prohibition device 7 performs the drive prohibition control (e.g., brake lock, or engine lock) in response to the drive prohibition instruction, thereby prohibiting the vehicle 100 from being driven.

Then, the failure handling program proceeds to step 150, where the controller 9 determines whether all the substitute mirrors corresponding to the capture/display functions, which are determined at step S110 to have a failure, are in the used position. A reason for this is that the driver can see the area around the vehicle without the capture/display function by using the corresponding substitute mirror. As an example, FIG. 13 depicts the substitute left side mirror 4a that is in the used position. If all the corresponding substitute mirrors are in the used position corresponding to YES at step 150, the failure handling program proceeds to step 160. In contrast, if at least one of the corresponding substitute mirrors is in the unused position corresponding to NO at step 150, the failure handling program repeats step 150.

At step 160, the controller 9 removes the prohibition on driving the vehicle 100. Specifically, the controller 9 sends the drive prohibition removal instruction to the drive prohibition device 7, and the drive prohibition device 7 stops the drive prohibition control in response to the drive prohibition removal instruction, thereby allowing the vehicle 100 to be driven. When the prohibition on driving the vehicle 100 is removed, the controller 9 causes the light emitter in the failure reporting position to be in the failure non-reporting position and causes the activated sound emitter to be deactivated.

Then, the failure handling program proceeds to step 170, where the controller 9 determines whether the ignition switch of the vehicle 100 is OFF. If the ignition switch is ON corresponding to NO at step 170, the failure handling program returns to step 110. In contrast, if the ignition switch is OFF corresponding to YES at step 170, the failure handling program ends after turning OFF the light emitters 2a-2c and the sound emitters 3a-3c.

As described above, according to the embodiment, when the ignition switch of the vehicle 100 is ON, the controller 9 executes the failure handling program shown in FIG. 10 so as to perform the failure handling function 93. In the failure handling function 93, when the controller 9 detects that a failure occurs in at least one of the left side capture/display function, the right side capture/display function, and the center capture/display function of the capture/display function 91 (refer to step 110), the controller 9 reports the occurrence of the failure to a person around the vehicle 100 by light and sound (refer to step 120). Thus, a person outside the vehicle 100 can find out that a failure occurs in the capture/display function 91 of the vehicle 100. For example, police can find out the failure by viewing the vehicle 100 from the outside and crack down on the vehicle 100 for poor maintenance. For another example, if a law demanding that a failure in an electronic mirror system should be reported outside a vehicle is enacted, the electronic mirror system of the embodiment can comply with the law.

Further, according to the embodiment, when the occurrence of the failure is reported by light and sound, only the light emitter corresponding to the capture/display function having the failure is put into the failure reporting position so as to emit a light with a specific color, and only the sound emitter corresponding to the capture/display function having the failure is activated so as to emit a sound. Therefore, by viewing the vehicle 100 from the outside, it can be easily determined that which capture/display function of the capture/display function 91 malfunctions.

Further, according to the embodiment, the controller 9 reports the occurrence of the failure to the external wireless communication apparatus outside the vehicle 100 by using the communication device 5 and also reports the occurrence of the failure to the driver inside the vehicle 100 (refer to step 120).

Then, the controller 9 requests the driver to pull over to a safe place and stop the vehicle 100 (refer to step 133), if the vehicle 100 is running at the time of the occurrence of the failure. After the vehicle 100 is stopped or if the vehicle 100 is already stopped at the time of the occurrence of the failure (corresponding to NO at step 130), the controller 9 reports the occurrence of the failure to the driver and notifies the driver that the vehicle 100 will be prohibited from being driven (refer to step 135). Then, the controller 9 prohibits the vehicle 100 from being driven (refer to step 140).

In this way, the controller 9 automatically prohibits the vehicle 100 from being driven, when a failure occurs in the capture/display function 91 of the electronic mirror system. In such an approach, it is possible to reduce the chance (i.e., risk) that the driver will drive the vehicle 100 in the event of the failure.

Further, according to the embodiment, when a failure is detected during running of the vehicle 100, the controller 9 provides the driver with a waning (i.e., displayed warning message and/or audible warning message) that urges the driver to stop the vehicle 100 in a safe place. Then, the controller 9 prohibits the vehicle 100 from being driven, after the vehicle 100 is stopped. In such an approach, it is possible to remove the chance (i.e., risk) that the vehicle 100 will be forced to be prohibited from being driven during running of the vehicle 100. Thus, the vehicle 100 can be safely prohibited from being driven.

Then, when the controller 9 detects that all the substitute mirrors corresponding to the failed capture/display functions of the capture/display function 91 are in the used position (refer to step 150), the controller 9 removes the prohibition on driving the vehicle 100 (refer to step 160). Thus, even when a failure occurs in the capture/display function 91, the vehicle 100 can be allowed to be driven by using the substitute mirrors.

In this case, using the substitute mirrors 4a-4c allows the driver to view the area around the vehicle 100 in the almost same manner as before the occurrence of the failure of the capture/display function 91. Therefore, removing the prohibition on driving the vehicle 100 under a condition where the substitute mirrors 4a-4c are in use does not cause a problem. Thus, unnecessary prohibition on driving the vehicle 100 can be prevented.

(Modifications)

The embodiment described above can be modified in various ways, for example, as follows.

According to the embodiment, the controller 9 directly detects a failure of the capture/display function 91. Alternatively, the controller 9 can indirectly detect a failure of the capture/display function 91.

For example, the electronic mirror system can include three camera failure detection circuits, each of which is configured to detect a failure of a corresponding one of the cameras 1a-1c. In this case, each camera failure detection circuit can send a camera failure detection signal to the controller 9 upon detection of a failure of the corresponding camera. In such an approach, the controller 9 can indirectly detect failures of the cameras 1a-1c through the camera failure detection circuits. For example, the camera failure detection circuit can monitor a synchronization signal of the image outputted from the corresponding camera and determine, based on stability of the synchronization signal, whether or not a failure occurs in the corresponding camera. For another example, the camera failure detection circuit can monitor a drive voltage of the corresponding camera and determine, based on the drive voltage, whether or not a failure occurs in the corresponding camera.

Likewise, the electronic mirror system can include three display failure detection circuits, each of which is configured to detect a failure of a corresponding one of the displays 8a-8c. In this case, each display failure detection circuit can send a display failure detection signal to the controller 9 upon detection of a failure of the corresponding display. In such an approach, the controller 9 can indirectly detect failures of the displays 8a-8c through the display failure detection circuits.

For example, when the displays 8a-8c are cathode ray tube (CRT) displays, the display failure detection circuits can detect failures of the displays 8a-8c by monitoring an output current/voltage value of at least one of a power supply circuit, a horizontal/vertical deflection circuit, and a booster circuit. For another example, when the displays 8a-8c are liquid crystal display (LCD) displays, the display failure detection circuits can detect failures of the displays 8a-8c by monitoring at least one of a liquid crystal driving signal and a backlight driving signal.

Likewise, the electronic mirror system can include six cable break detection circuits, each of which is configured to detect a break in a corresponding one of the cables 10a-10c and 11a-11c. In this case, each cable break detection circuit can send a break detection signal to the controller 9 upon detection of a break in the corresponding cable. In such an approach, the controller 9 can indirectly detect failures (i.e., breaks) of the cables 10a-10c and 11a-11c through the cable break detection circuits.

In this way, the controller 9 can work in conjunction with the camera failure detection circuit, the display failure detection circuit, and the cable break detection circuit so as to serve as a failure detection circuit.

Specifically, the controller 9 can determine that a failure occurs in the left capture/display function, if the above failure/break detection circuits detect that a failure or a break occurs in at least one of the left side camera 1a, the cable 10a, the cable 11a, and the left side display 8a. Likewise, the controller 9 can determine that a failure occurs in the right capture/display function, if the above failure/break detection circuits detect that a failure or a break occurs in at least one of the right side camera 1b, the cable 10b, the cable 11b, and the right side display 8b. Likewise, the controller 9 can determine that a failure occurs in the center capture/display function, if the above failure/break detection circuits detect that a failure or a break occurs in at least one of the center camera 1c, the cable 10c, the cable 11c, and the center display 8c.

Further, according to the embodiment, the failure detection function 92 checks for failure of the left capture/display function, the right capture/display function, and the center capture/display function of the capture/display function 91, separately. Alternatively, the failure detection function 92 can check for failure of the capture/display function 91, collectively. That is, the controller 9 performs the failure detention function 92 to determine whether or not the entire capture/display function 91 operates properly. For example, when the controller 9 detects that a failure occurs in at least one of the left capture/display function, the right capture/display function, and the center capture/display function, the controller 9 determines that the entire capture/display function 91 malfunctions.

In this case, the flow chart of FIG. 10 is modified as follows. If the controller 9 detects at step 110 that a failure occurs in at least one of the left capture/display function, the right capture/display function, and the center capture/display function, the controller 9 can put all the light emitters 2a-2c in the failure reporting position and activate all the sound emitters 3a-3c at step 120.

Then, if the controller 9 determines at step 150 that all the substitute mirrors 4a-4c are in the used position, the controller 9 can remove the prohibition on driving the vehicle 100 at step 160.

Further, according to the embodiment, the electronic mirror system includes the substitute mirrors 4a-4c that are used when a failure occurs in the capture/display function 91. Alternatively, the electronic mirror system can include no substitute mirror. That is, the vehicle 100 can have none of left and right side mirrors and a rear view mirror.

Further, according to the embodiment, the electronic mirror system is discussed as an example of an outside view monitor system of the present invention. Alternatively, the outside view monitor system can be applied to other systems that capture an image of the area around a vehicle and displays the captured image on a display in the vehicle. For example, the outside view monitor system can be applied to a rear view monitor system, which captures an image of a blind spot behind a vehicle and displays the captured image on a display in the vehicle.

Further, according to the embodiment, the displays 8a-8c are mounted on the vehicle 100. Alternatively, an additional display (e.g., a display used in a navigation system) can be mounted on the vehicle 100 along with the displays 8a-8c. In this case, the controller 9 can cause the additional display to display the warning message such as shown in FIG. 12 in the event of the failure.

Further, according to the embodiment, the images captured by the cameras 1a-1c are displayed on the displays 8a-8c, respectively. Alternatively, the images captured by the cameras 1a-1c can be combined, and the combined image can be displayed on at least one of the displays 8a-8c.

Further, according to the embodiment, the controller 9 achieves the functions (e.g., the failure handling function 93) by executing the programs (e.g., the failure handling program shown in FIG. 10). That is, the functions are achieved by software. Alternatively, the functions can be achieved by hardware such as a field programmable gate array (FPGA).

Such changes and modifications are to be understood as being within the scope of the present invention as defined by the appended claims.

What is claimed is:

1. A monitor system for a vehicle comprising:
a camera configured to capture an image of an area around the vehicle;
a display configured to display the captured image to a driver of the vehicle;
a failure detection device configured to detect a failure of a function, the function allowing the display to display the captured image; and
a prohibition control device configured to prohibit the vehicle from being driven in response to detection of the failure by the failure detection device.

2. The monitor system according to claim 1, wherein
the prohibition control device provides the driver with a warning that urges the driver to stop the vehicle, when the vehicle runs at the time of the detection of the failure, and
the prohibition control device prohibits the vehicle from being driven, after the vehicle is stopped.

3. The monitor system according to claim 1, further comprising:
a substitute device serving as a substitute for the function and configured to allow the driver to see the area around the vehicle without the function, wherein
the prohibition control device removes prohibition on driving the vehicle in response to detection that the substitute device is in use.

4. The monitor system according to claim 2, further comprising:
a substitute device serving as a substitute for the function and configured to allow the driver to see the area around the vehicle without the function, wherein
the prohibition control device removes prohibition on driving the vehicle in response to detection that the substitute device is in use.

5. A vehicle comprising:
the monitor system of claim 1, wherein
the function of the monitor system serves as a substitute for at least one of a side mirror and a rear view mirror, and
the vehicle does not have the at least one of the side mirror and the rear view mirror.

6. The vehicle according to claim 5, wherein
the prohibition control device provides the driver with a warning that urges the driver to stop the vehicle, when the vehicle runs at the time of the detection of the failure, and
the prohibition control device prohibits the vehicle from being driven, after the vehicle is stopped.
